(19) United States
(12) Patent Application Publication
(10) Pub. No.: US 2025/0239152 A1
(43) Pub. Date: Jul. 24, 2025

(54) DRIVING NEGOTIATION METHOD AND APPARATUS

(71) Applicant: HYUNDAI AUTOEVER CORP., Seoul (KR)

(72) Inventor: KeonWoo Lee, Seoul (KR)

(73) Assignee: HYUNDAI AUTOEVER CORP., Seoul (KR)

(21) Appl. No.: 18/951,044

(22) Filed: Nov. 18, 2024

(30) Foreign Application Priority Data
Jan. 22, 2024 (KR) 10-2024-0009735

(51) Int. Cl. G08G 1/01; H04W 4/40

(52) U.S. Cl. CPC G08G 1/0116; H04W 4/40

(57) ABSTRACT

A driving negotiation method includes transmitting, by a first processor of a first driving negotiation apparatus of a first roadside unit (RSU), a first packet including state information of a plurality of first vehicles within first coverage of the first RSU to a second driving negotiation apparatus of an adjacent second RSU, when completing driving negotiations. The driving negotiation method also includes broadcasting, by a second processor of the second driving negotiation apparatus, failure vehicle information to at least one second vehicle within second coverage of the second RSU when a vehicle in a failure state is present in the first packet. The driving negotiation method additionally includes transmitting, by the second processor, a second packet including state information of the at least one second vehicle and the state information of the plurality of first vehicles to a third driving negotiation apparatus of an adjacent third RSU.

### CROSS-REFERENCE TO RELATED APPLICATION

This application claims priority from and the benefit of Korean Patent Application No. 10-2024-0009735, filed on Jan. 22, 2024, the entire contents of which are hereby incorporated herein by reference.

### TECHNICAL FIELD

The present disclosure relates to a driving negotiation method and apparatus.

### BACKGROUND

The statements in this section merely provide background information related to the present disclosure and may not constitute prior art.

A cooperative intelligent transportation system (C-ITS) that represents a next generation intelligent transportation system (ITS) refers to a traffic safety-focused next generation ITS that enables bidirectional, continuous data sharing between vehicles and between vehicles and infrastructure. This system departs from traditional ITS, which is traffic management-centric and provides unidirectional information from traffic infrastructure to vehicles, thereby enabling the proactive handling and prevention of outbreak situations.

In relation to the next generation ITS, research for introducing a connected vehicle is also actively carried out. The connected vehicle refers to a vehicle that drives in a stand-alone manner and that is provided with connectivity based on vehicle to everything (V2X) communication. Such a connected vehicle has an object of checking a traffic flow and an accident situation and providing or using various services, such as safe driving and the prevention of traffic congestion, through bidirectional communication using vehicle to infrastructure (V2I), vehicle to network (V2N), vehicle to vehicle (V2V), vehicle to nomadic devices (V2ND), vehicle to pedestrian (V2P), or vehicle to everything (V2X).

In vehicle communication for vehicle safety, dedicated short range communication (DSRC) for vehicles, which has been extended from IEEE 802 standards, has been standardized and researched as IEEE 802.11p, also referred to as wireless access for vehicle environment (WAVE). Vehicle communication standardization using long term evolution (LTE) technology, which is a mobile communication network, has started in earnest since the beginning of 2015. 3GPP, which is an international mobile communication standardization organization, has prepared a base for the spread of vehicle communication by completing standardization for LTE vehicle communication in March 2017, including reducing the delay time and supporting direct communication between vehicles through the LTE technology. Thereafter, discussion for performance improvements and convergence with the new radio (NR) (5G) communication technology is in progress.

There is a limit to the handling of stability with respect to a blind spot or an outbreak situation on a road through only the sensor of an autonomous vehicle. In particular, when various driving situations occur at a non-signal intersection, a circular intersection, and a joining road, there is a limit to a rapid determination of an autonomous vehicle and stability corresponding to the rapid determination.

For this reason, a driving negotiation apparatus for driving negotiations is mounted on a roadside unit (RSU). Driving negotiations for a lane change request and the sharing of a joining plan are performed by using the driving negotiation apparatus.

However, a conventional technology has disadvantages in that the state of a vehicle on a leading road that is not included in coverage of an RSU cannot be known because an operation according to driving negotiations is performed only within the coverage of the RSU and thus the range of driving negotiations is limited.

### SUMMARY

Various embodiments are directed to providing a driving negotiation method and apparatus that enable driving negotiations of a vehicle to be shared within coverage of a roadside unit (RSU) that is installed on a roadside.

According to an embodiment, a driving negotiation method is provided. The driving negotiation method includes transmitting, by a first processor of a first driving negotiation apparatus of a first road side unit (RSU), a first packet including state information of a plurality of first vehicles within first coverage of the first RSU to a second driving negotiation apparatus of an adjacent second RSU, when completing driving negotiations. The driving negotiation method also includes broadcasting, by a second processor of the second driving negotiation apparatus, failure vehicle information to at least one second vehicle within second coverage of the second RSU when a vehicle in a failure state is present in the first packet. The driving negotiation method additionally includes transmitting, by the second processor, a second packet including state information of the at least one second vehicle and the state information of the plurality of first vehicles to a third driving negotiation apparatus of an adjacent third RSU.

In some embodiments of the present disclosure, the first packet or the second packet may include at least one of driving negotiation apparatus identification information, coverage flags, a vehicle identifier, or a failure mode.

In some embodiments of the present disclosure, the coverage flags may include inner coverage and outer coverage. The failure mode may indicate whether a corresponding vehicle fails.

In some embodiments of the present disclosure, a vehicle state information size that is managed by each of the first driving negotiation apparatus, the second driving negotiation apparatus, and the third driving negotiation apparatus may be adjusted depending on resources of each of the first driving negotiation apparatus, the second driving negotiation apparatus, and the third driving negotiation apparatus.

In some embodiments of the present disclosure, the method may further include, after the transmitting of the second packet to the third driving negotiation apparatus, broadcasting, by a third processor of the third driving negotiation apparatus, the failure vehicle information to at least one third vehicle within third coverage of the third RSU when the vehicle in the failure state is present in the second packet. The method may further still include transmitting, by the third processor, a third packet including state information of the at least one third vehicle, the state information of the at least one second vehicle, or the state information of the plurality of first vehicles to a fourth driving negotiation apparatus of an adjacent fourth RSU.

In some embodiments of the present disclosure, the first driving negotiation apparatus, the second driving negotiation apparatus, and the third driving negotiation apparatus may be sequentially installed on the basis of a driving direction of a vehicle.

According to an embodiment, a driving negotiation apparatus is provided. The driving negotiation apparatus includes a communication module configured to support vehicle to everything (V2X) communication and a processor connected to the communication module. The processor is configured to transmit, to an adjacent driving negotiation apparatus, a first packet including state information of a plurality of first vehicles within coverage of the driving negotiation apparatus when completing driving negotiations of a driving negotiation request vehicle.

In some embodiments of the present disclosure, the processor may be configured to, when receiving a cooperation request message from the driving negotiation request vehicle, complete the driving negotiations of the driving negotiation request vehicle by generating a cooperation relay message that includes a type code of additional information necessary for negotiations in the cooperation request message, broadcasting the cooperation relay message to the plurality of first vehicles, receiving cooperation reply messages corresponding to the cooperation relay message from the plurality of first vehicles, and transmitting a message for negotiability or non-negotiability to the driving negotiation request vehicle based on the cooperation reply message.

In some embodiments of the present disclosure, the first packet may include at least one of driving negotiation apparatus identification information, coverage flags, a vehicle identifier, or a failure mode.

In some embodiments of the present disclosure, the coverage flags may include inner coverage and outer coverage. The state information may indicate whether a corresponding vehicle fails.

In some embodiments of the present disclosure, the adjacent driving negotiation apparatus may be installed on a following road of the driving negotiation apparatus on the basis of a driving direction of the driving negotiation request vehicle.

In some embodiments of the present disclosure, the processor may be configured to, when receiving a packet from the adjacent driving negotiation apparatus, analyze the received packet and broadcast failure vehicle information to at least one vehicle within coverage of the driving negotiation apparatus when a vehicle in a failure state is present in the received packet.

In some embodiments of the present disclosure, the adjacent driving negotiation apparatus may be installed on a leading road of the driving negotiation apparatus on the basis of a driving direction of the driving negotiation request vehicle.

In some embodiments of the present disclosure, the processor may be configured to transmit, to an adjacent driving negotiation apparatus, a packet including state information of the at least one vehicle included in the received packet and the state information of the plurality of first vehicles.

In some embodiments of the present disclosure, a vehicle state information size that is managed by the driving negotiation apparatus may be adjusted depending on resources of the driving negotiation apparatus.

The driving negotiation method and apparatus according to embodiments of the present disclosure may support driving negotiations within a wider range through the exchange of information between the driving negotiation apparatuses installed in different RSUs, by enabling driving negotiations of vehicles within coverage of the RSUs installed in streets.

Furthermore, the driving negotiation method and apparatus according to embodiments of the present disclosure may modify a driving strategy suitably for a failure (or abnormal) vehicle on a leading road and perform even the optimization of the road, by obtaining state information of a vehicle on a leading road that is not included in coverage of a corresponding RSU through the driving negotiation apparatus.

### BRIEF DESCRIPTION OF THE DRAWINGS

FIG. 1 is a diagram for describing a system for driving negotiations according to an embodiment of the present disclosure.

FIG. 2 is a diagram for describing a driving negotiation method according to an embodiment of the present disclosure.

FIG. 3 is a diagram for describing driving negotiations according to an embodiment of the present disclosure.

FIG. 4 is a diagram for describing the structure of a packet according to an embodiment of the present disclosure.

FIG. 5 is a diagram for describing state information of a vehicle that is transmitted between driving negotiation apparatuses according to an embodiment of the present disclosure.

FIG. 6 is a diagram for describing state information of a vehicle that is managed by the driving negotiation apparatus according to an embodiment of the present disclosure.

FIG. 7 is a block diagram schematically illustrating a construction of the driving negotiation apparatus according to an embodiment of the present disclosure.

FIG. 8 is a diagram for describing a driving negotiation method of the driving negotiation apparatus that has been dualized according to an embodiment of the present disclosure.

### DETAILED DESCRIPTION

Hereinafter, a driving negotiation method and apparatus according to embodiments of the present disclosure are described in detail with reference to the accompanying drawings. In the accompanying drawings, the thicknesses of lines or the sizes of components illustrated in the drawings may be exaggerated for clarity of description and convenience. Terms described below are defined by taking into consideration their functions in the present disclosure, and may be changed depending on a user or operator's intention or practice. Accordingly, such terms should be defined based on the overall contents of this specification.

When a component, device, module, element, or the like of the present disclosure is described as having a purpose or performing an operation, function, or the like, the component, device, or element should be considered herein as being “configured to” meet that purpose or perform that operation or function.

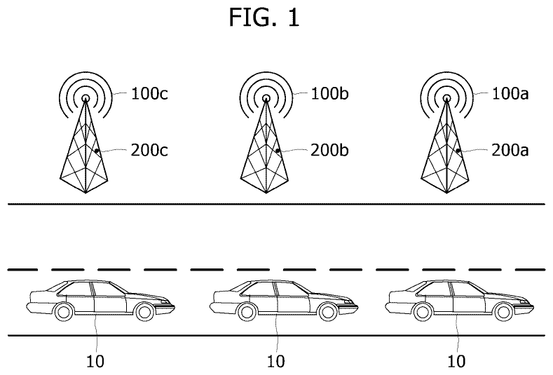

FIG. 1 is a diagram for describing a system for driving negotiations according to an embodiment of the present disclosure.

Referring to FIG. 1, the system for driving negotiations according to an embodiment of the present disclosure includes RSUs 100a, 100b, and 100c (hereinafter referred to as “100”) that are installed to be adjacent to each other and driving negotiation apparatus 200a, 200b, and 200c (hereinafter referred to as “200”).

The RSU 100 may collect vehicle location and counterpart information from a vehicle 10 (or a vehicle terminal) through vehicle to infrastructure (V2I) communication, and may provide the vehicle 10 (or the vehicle terminal) with related information, such as traffic, an outbreak, a signal, and a pedestrian, or certificate information, global positioning system (GPS) information, etc.

The driving negotiation apparatus 200 may be combined with the RSU 100 or installed as a component of the RSU 100. In another implementation example, the driving negotiation apparatus 200 may be mounted on another infrastructure apparatus or road infrastructure support system including a wireless communication module and a processor in addition to the RSU 100. Hereinafter, for convenience of description, the driving negotiation apparatus 200 is described as an apparatus that is combined with the RSU 100 or installed as a component of the RSU 100.

The driving negotiation apparatus 200 may provide corresponding vehicles 10 with a cooperation request message for driving negotiations and a driving negotiations/cooperation process to enable the vehicle 10 to secure stability and effectively take measures with respect to a blind spot, an outbreak situation, etc. or in order to support a rapid determination and the securing of stability for the vehicle 10 in various driving environments or driving spaces, such as a non-signal intersection, a circular intersection, an interchange, and/or road joining.

Furthermore, when driving negotiations are completed, the driving negotiation apparatus 200 may generate a first packet including state information of a plurality of vehicles 10 within its coverage (i.e., the coverage of the RSU 100), and may transmit the first packet to an adjacent driving negotiation apparatus 200.

Furthermore, when receiving a packet from an adjacent driving negotiation apparatus 200, the driving negotiation apparatus 200 may analyze the received packet, and may broadcast failure vehicle information to at least one vehicles 10 within its coverage when the failure vehicle information is present in the received packet. Furthermore, when information to be updated is present as a result of the analysis of the received packet, the driving negotiation apparatus 200 may generate a second packet including the state information of the vehicles 10 within its coverage and the state information included in the received packet, and may transmit the second packet to an adjacent driving negotiation apparatus 200.

The size of vehicle state information (hereinafter referred to as a “management specification”) that is managed by the driving negotiation apparatus 200 may be predetermined because resources (e.g., the capacity of memory 220 (or buffer), i.e., a communication capacity) of the driving negotiation apparatus 200 have been determined.

If the driving negotiation apparatus 200 indefinitely transmits vehicle state information, the internal memory 220 (or buffer) of the driving negotiation apparatus 200 may become insufficient or the transmission speed of data of the driving negotiation apparatus 200 may be limited. Accordingly, the driving negotiation apparatus 200 may set the management specification (i.e., a management vehicle state information size) suitable for a situation, and may overwrite the vehicle state information based on the management specification (i.e., the management vehicle state information size) when receiving the vehicle state information from an adjacent driving negotiation apparatus 200.

As described above, the driving negotiation apparatus 200 may manage vehicle state information. The vehicle state information may be added to be communicated between the driving negotiation apparatuses 200.

For example, a first driving negotiation apparatus 200a may transmit state information of the first vehicles 10 within its first coverage to a second driving negotiation apparatus 200b. The second driving negotiation apparatus 200b may transmit, to a third driving negotiation apparatus 200c, state information of the second vehicles 10 within its second coverage and the state information of the first vehicles that is received from the first driving negotiation apparatus 200a. In this case, the first driving negotiation apparatus 200a, the second driving negotiation apparatus 200b, and the third driving negotiation apparatus 200c may be sequentially installed on the basis of the driving direction of the vehicle 10. Thus, the order of installation of the first driving negotiation apparatus 200a, the second driving negotiation apparatus 200b, and the third driving negotiation apparatus 200c may correspond to an order in which the first driving negotiation apparatus 200a, the second driving negotiation apparatus 200b, and the third driving negotiation apparatus 200c have been installed on the leading road on the basis of the driving direction of the vehicle 10.

As a result, the driving negotiation apparatus 200 that is disposed at the very end of the driving negotiation apparatuses may rapidly obtain information of the vehicle 10 that is problematic, and may perform optimization of a road in addition to driving negotiations of the vehicle 10.

The driving negotiation apparatus 200 may be attacked for malicious purposes or may be subjected to a non-recoverable failure due to an abnormal error. When a non-recoverable failure occurs in a specific driving negotiation apparatus during communication between the driving negotiation apparatuses 200, malfunction may occur in the sharing of driving negotiations between the driving negotiation apparatuses 200. Furthermore, delay may occur in a specific driving negotiation apparatus within corresponding coverage due to the excess of negotiation driving packets at the place (e.g., a congestion situation or a section in which an accident frequently occurs) at which many negotiation messages are present.

Accordingly, in an embodiment of the present disclosure, the driving negotiation apparatus 200 within corresponding coverage may be dualized. For example, the first driving negotiation apparatus 200a within the first coverage may be constructed as a first master driving negotiation apparatus (not illustrated) and a first slave driving negotiation apparatus (not illustrated). The second driving negotiation apparatus 200b within the second coverage may be constructed as a second master driving negotiation apparatus (not illustrated) and a second slave driving negotiation apparatus (not illustrated). The third driving negotiation apparatus 200c within the third coverage may be constructed as a third master driving negotiation apparatus (not illustrated) and a third slave driving negotiation apparatus (not illustrated).

As described above, the driving negotiation apparatus 200 within its coverage may be dualized as a master driving negotiation apparatus and a slave driving negotiation apparatus. In this case, when the master driving negotiation apparatus is in an abnormal state, the slave driving negotiation apparatus may perform a role as the master driving negotiation apparatus. In this case, the abnormal state may include a case in which the master driving negotiation apparatus is attacked for malicious purposes or subjected to a non-recoverable failure due to an abnormal error and a case in which delay occurs in the master driving negotiation apparatus due to a heavy packet load.

The slave driving negotiation apparatus may transmit a heartbeat packet to the master driving negotiation apparatus at regular intervals in order to identify the state of the master driving negotiation apparatus.

The master driving negotiation apparatus in a normal state may transmit a reply packet for the heartbeat packet to the slave driving negotiation apparatus. The master driving negotiation apparatus in the abnormal state is not able to transmit a reply packet for the heartbeat packet to the slave driving negotiation apparatus.

If a reply packet for the heartbeat packet is not received from the master driving negotiation apparatus, the slave driving negotiation apparatus may determine the master driving negotiation apparatus to be in the abnormal state.

When determining that the master driving negotiation apparatus is in the abnormal state, the slave driving negotiation apparatus may switch to a master, i.e., the master driving negotiation apparatus, and may perform a role as the master driving negotiation apparatus. Accordingly, the slave driving negotiation apparatus that becomes the master may perform driving negotiations for corresponding coverage. In this case, the slave driving negotiation apparatus that becomes the master may transmit a heartbeat packet to the master driving negotiation apparatus at regular intervals.

The slave driving negotiation apparatus that becomes the master may operate as the master until the state of the master driving negotiation apparatus returns to the normal state. In an embodiment, when receiving the reply packet for the heartbeat packet from the master driving negotiation apparatus, the slave driving negotiation apparatus that becomes the master may determine that the state of the master driving negotiation apparatus has returned to the normal state. When determining that the state of the master driving negotiation apparatus has returned to the normal state, the slave driving negotiation apparatus that becomes the master may hand over the role of the master to the master driving negotiation apparatus, and may operate as a slave again.

As described above, if the driving negotiation apparatus within the coverage is dualized, fail-safe can be guaranteed because the slave driving negotiation apparatus may substitute for the role of the master driving negotiation apparatus when a non-recoverable failure occurs in the master driving negotiation apparatus.

Furthermore, the slave driving negotiation apparatus may process the negotiation message of the master driving negotiation apparatus through load balancing, thereby reducing bottlenecks.

Furthermore, communication between vehicles on a road may be stably performed and an attack according to malicious purposes may be handled through the dualized driving negotiation apparatus.

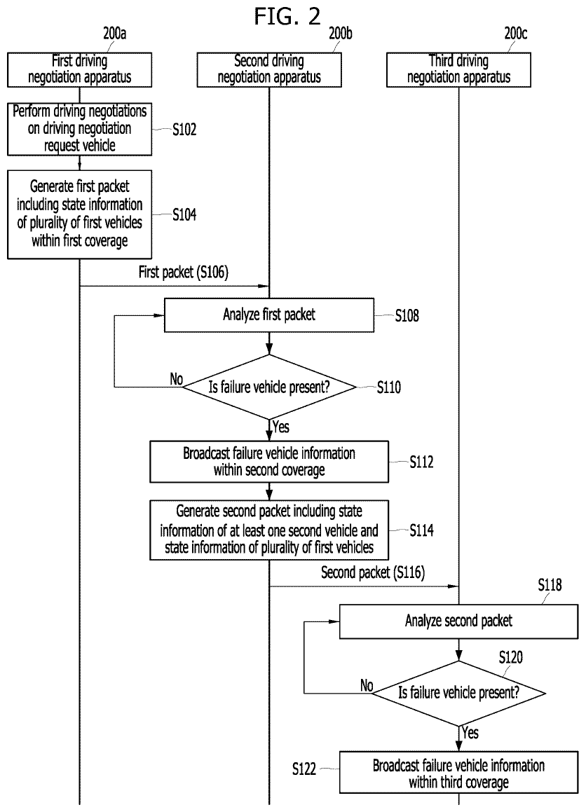

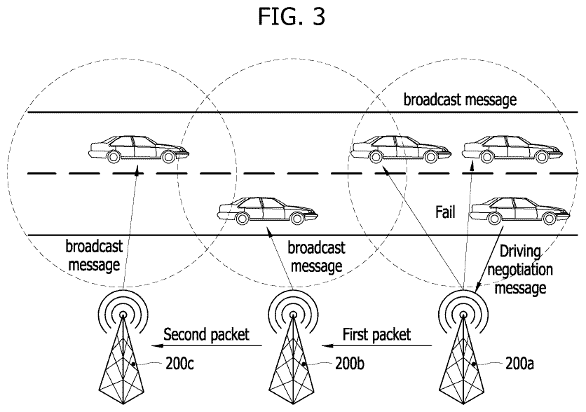

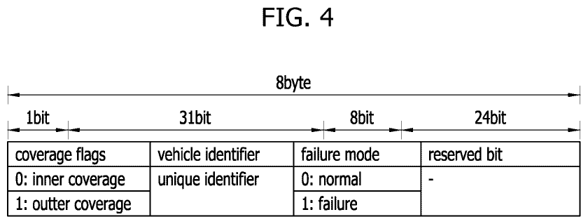

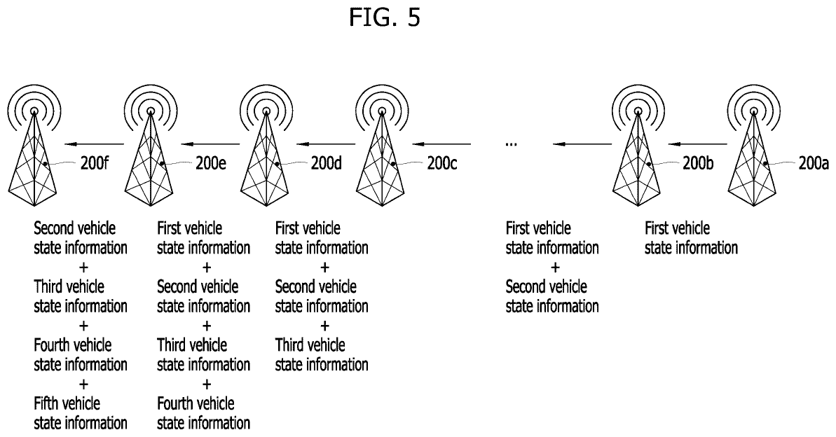

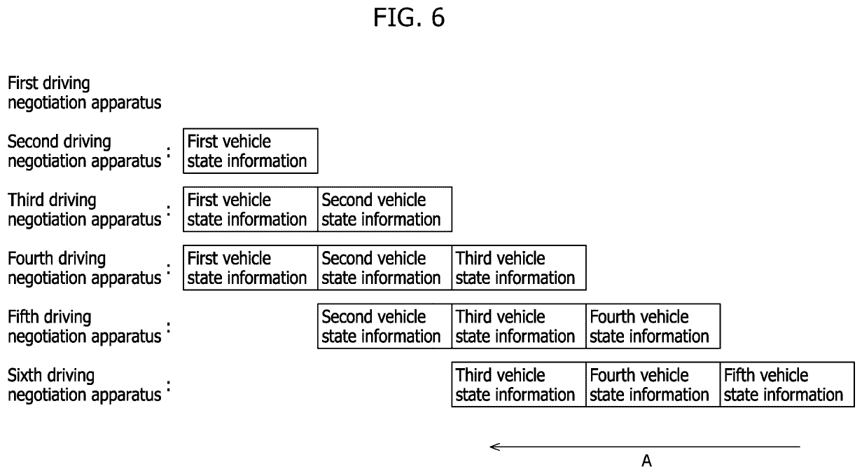

FIG. 2 is a diagram for describing a driving negotiation method according to an embodiment of the present disclosure. FIG. 3 is a diagram for describing driving negotiations according to an embodiment of the present disclosure. FIG. 4 is a diagram for describing the structure of a packet according to an embodiment of the present disclosure. FIG. 5 is a diagram for describing state information of vehicles that is transmitted between the driving negotiation apparatuses according to an embodiment of the present disclosure. FIG. 6 is a diagram for describing state information of vehicles that is managed by the driving negotiation apparatus according to an embodiment of the present disclosure.

Operations of first to N-th driving negotiation apparatuses described below may be performed by first to N-th processors that are included in the first to N-th driving negotiation apparatuses, respectively (N is the number of driving negotiation apparatuses and may be a natural number equal to or greater than 2).

Referring to FIGS. 2 and 3, in an operation S102, the first driving negotiation apparatus 200a performs driving negotiations on a driving negotiation request vehicle. The driving negotiation request vehicle may refer to a vehicle that has requested the driving negotiations, among a plurality of first vehicles within the first coverage of the first driving negotiation apparatus 200a (or the first RSU 100a).

When receiving a cooperation request message from the driving negotiation request vehicle, the first driving negotiation apparatus 200a may generate a cooperation relay message that includes a type code of additional information necessary for negotiations in the cooperation request message, and may broadcast the cooperation relay message to surrounding vehicles. The cooperation request message may include vehicle identification information, a time stamp, and negotiation request data of the driving negotiation request vehicle. The negotiation request data may include request type data, such as a vehicle speed, a lane change, and/or lane joining. The data of the vehicle speed is negotiation message information relating to a speed adjustment plan, and may include data elements, such as overtaking, deceleration, and/or a stop. The data of the lane change is negotiation message information for the lane change plan, and may include data elements, such as avoidance, an accident, cutting-in, and/or a pedestrian. The data of the lane joining is a negotiation message for the joining plan, and may include data elements, such as a confluence, an intersection, and/or a roundabout. Furthermore, the cooperation request message may further include message identification information. The message identification information is a current driving negotiation session ID value, and may be used to define a process up to a reply after the driving negotiation request as one session.

The first driving negotiation apparatus 200a that has received the cooperation request message may generate a cooperation relay message that includes a type code of additional information necessary for negotiations in the cooperation request message, based on a driving cooperation type that is targeted by the vehicle terminal of the driving negotiation request vehicle for driving cooperation or driving negotiations. The additional information may include a vehicle speed change, a lane change, lane joining, a collision warning, collision avoidance, an intersection warning, a road state warning on freezing, an interchange warning, and/or information that is associated with toll collection.

After generating the cooperation relay message, the first driving negotiation apparatus may broadcast the cooperation relay message to at least one first vehicle within the first coverage of the first RSU 100a.

The at least one first vehicle that has received the cooperation relay message may transmit a cooperation reply message to the first driving negotiation apparatus. The cooperation reply message may include vehicle identification information, a time stamp, negotiation reply data, message identification information, and failure information. The negotiation reply data may include a reply value for the negotiations of the first vehicle and information necessary for negotiations. The reply value for the negotiations may include a data element for agreement or refusal. The message identification information is useful in efficiently identifying and relaying a specific cooperation reply message and a cooperation reply message corresponding to the specific cooperation reply message, when the first driving negotiation apparatus 200a processes a plurality of cooperation request messages and a plurality of cooperation reply messages in 1 to many (N) or multiple (M): N environments. The failure information may indicate the failure of a corresponding vehicle.

The first driving negotiation apparatus 200a may transmit a message related to driving negotiability or driving non-negotiability to the driving negotiation request vehicle based on the cooperation reply message. The first driving negotiation apparatus 200a may transmit the message for negotiability or non-negotiability to the first vehicle in a broadcast way based on the cooperation reply message.

When the driving negotiations for the driving negotiation request vehicle are completed as the results of the execution in the operation S102, the first driving negotiation apparatus 200a may generate a first packet including state information of the plurality of first vehicles within the first coverage of the first driving negotiation apparatus 200a (or the first RSU 100a) in an operation S104, and may transmit the first packet to an adjacent second driving negotiation apparatus 200b in an operation S106.

The first packet is information that is transmitted to the adjacent second driving negotiation apparatus 200b, and may include state information of the first vehicle within the first coverage of the first RSU 100a. The vehicle state information may include vehicle identification information, a failure, etc. The second driving negotiation apparatus 200b may refer to a driving negotiation apparatus mounted on the second RSU 100b that has been installed on a following road of the first driving negotiation apparatus 200a (or the first RSU 100a) on the basis of the driving direction of the vehicle.

If a plurality of first vehicles is present within the first coverage, the first driving negotiation apparatus 200a may generate state information of the first vehicles in a table form. The first driving negotiation apparatus 200a may generate the first packet including the state information of the first vehicles that is generated in the table form, and may transmit the first packet to the adjacent second driving negotiation apparatus 200b.

The first packet may include at least one of coverage flags, a vehicle identifier, and state information (i.e., a failure mode).

For example, as illustrated in FIG. 4, the first packet may consist of eight bytes. The coverage flags indicate whether a received packet is an inner or outer coverage packet, and may consist of 1 bit, for example. “0” may refer to inner coverage, and “1” may refer to outer coverage. The coverage flags help to check whether the received packet is a packet that is received from the driving negotiation apparatus 200 (the RSU 100) of adjacent (or outer) coverage or a packet of inner coverage. The vehicle identifier indicates the identifier of a vehicle that is present within corresponding coverage, and may be a unique value. The vehicle identifier may be 31 bits, for example. The failure mode is a flag for determining whether a vehicle fails, and may refer to 0 (normal) or 1 (failure). The failure mode may be 8 bits, for example. A reserved bit may be used for a subsequent increase in the number of vehicles or to store other pieces of information. The reserved bit may be 24 bits, for example.

In an operation S110, the second driving negotiation apparatus 200b determines whether a vehicle in the failure state is present in the first packet by analyzing the first packet in an operation S108. The second driving negotiation apparatus 200b may determine whether the vehicle in the failure state is present by identifying state information (i.e., the failure mode) of the first packet.

When the vehicle in the failure state is present as the results of the determination in the operation S110, the second driving negotiation apparatus 200b broadcasts failure vehicle information to the at least one second vehicle within the coverage of the second driving negotiation apparatus 200b (or the second RSU 100b) in an operation S112.

The second driving negotiation apparatus 200b may broadcast the fact that the preceding vehicle on a leading road is in a failure (or abnormal) situation. In response thereto, the at least one second vehicle that has received the failure vehicle information may modify its driving strategy suitably for the failure (or abnormal) vehicle on the leading road. The second driving negotiation apparatus 200b may be aware that there is a problem in the preceding vehicle that drives on the leading road by analyzing the first packet received from the first driving negotiation apparatus 200a, thereby enabling more robust driving negotiation.

In an operation S114, the second driving negotiation apparatus 200b may generate a second packet including state information of the at least one second vehicle and state information of the plurality of first vehicles. In an operation S116, the second driving negotiation apparatus 200b may transmit the second packet to the third driving negotiation apparatus 200c of an adjacent third RSU 100c.

Accordingly, the second driving negotiation apparatus 200b may generate the second packet including the state information of the at least one second vehicle within its second coverage and the state information of the plurality of first vehicles, which has been received from the first driving negotiation apparatus 200a.

The third driving negotiation apparatus 200c that has received the second packet determines whether the vehicle in the failure state is present in the second packet in an operation S120) by analyzing the second packet in an operation S118. In this case, the third driving negotiation apparatus 200c may receive the state information of the first vehicles within the first coverage and the state information of the second vehicle within the second coverage from the second driving negotiation apparatus 200b in a table form. Accordingly, the third driving negotiation apparatus 200c may determine whether the vehicle in the failure state is present by identifying the state information (i.e., the failure mode) of the second packet.

When the vehicle in the failure state is present as the results of the determination in the operation S120, the third driving negotiation apparatus 200c may broadcast failure vehicle information to at least one third vehicle within the third coverage of the third driving negotiation apparatus 200c (or the third RSU 100c) in an operation S122.

Accordingly, the third driving negotiation apparatus 200c may broadcast the fact that the preceding vehicle on the leading road is in the failure (or abnormal) situation. The at least one third vehicle that has received the failure vehicle information may modify its driving strategy suitably for the failure (or abnormal) vehicle on the leading road.

The third driving negotiation apparatus 200c may be aware that a problem occurs in the preceding vehicle that drives on the leading road by analyzing the second packet received from the second driving negotiation apparatus 200b, thereby enabling more robust driving negotiation.

Furthermore, the third driving negotiation apparatus 200c may transmit, to the fourth driving negotiation apparatus 200d of an adjacent fourth RSU (not illustrated), a third packet including the state information of the at least one third vehicle, the state information of the at least one second vehicle, and the state information of the plurality of first vehicles.

As described above, the first driving negotiation apparatus 200a may transmit the state information of the first vehicles within the first coverage to the second driving negotiation apparatus 200b. In response thereto, the second driving negotiation apparatus 200b may manage the state information of the first vehicles, and may transmit, to the third driving negotiation apparatus 200c, the state information of the second vehicle within the second coverage and the state information of the first vehicles that is received from the first driving negotiation apparatus 200a. In response thereto, the third driving negotiation apparatus 200c may manage the state information of the first vehicles and the state information of the second vehicle. As described above, each of the pieces of state information may be added so that the pieces of state information can be moved between the driving negotiation apparatuses 200. In this case, the management specification (e.g., a vehicle state information size) that is managed by each of the first to third driving negotiation apparatuses 200a, 200b, and 200c may be predetermined because resources (e.g., a buffer capacity or a communication capacity) of each of the first to third driving negotiation apparatuses 200a, 200b, and 200c has been determined.

For example, if driving negotiation apparatuses 200a, 200b, 200c, 200d, 200e, and 200f have been installed as illustrated in FIG. 5, state information that is managed by each of the driving negotiation apparatuses 200a, 200b, 200c, 200d, 200e, and 200f is described. In this case, it is assumed that the management specification of each of the driving negotiation apparatuses 200a, 200b, 200c, 200d, 200e, and 200f has been set as “3”.

The second driving negotiation apparatus 200b may manage first vehicle state information because the second driving negotiation apparatus 200b receives the first vehicle state information from the first driving negotiation apparatus 200a. The first vehicle state information may refer to state information of at least one first vehicle within the first coverage of the first driving negotiation apparatus 200a.

The second driving negotiation apparatus 200b may transmit, to the third driving negotiation apparatus 200c, second vehicle state information that refer to state information of at least one second vehicle within its second coverage and the first vehicle state information. In an embodiment, the second driving negotiation apparatus 200b may generate a second packet including the second vehicle state information and the first vehicle state information, and may transmit the generated second packet to the third driving negotiation apparatus 200c.

The third driving negotiation apparatus 200c may manage the second vehicle state information and the first vehicle state information because the third driving negotiation apparatus 200c receives vehicle state information from the second driving negotiation apparatus 200b. The third driving negotiation apparatus 200c may transmit, to the fourth driving negotiation apparatus 200d, third vehicle state information that refer to state information of at least one third vehicle within its third coverage, the second vehicle state information, and the first vehicle state information. In an embodiment, the third driving negotiation apparatus 200c may generate a third packet including the third vehicle state information, the second vehicle state information, and the first vehicle state information, and may transmit the generated third packet to the fourth driving negotiation apparatus 200d.

The fourth driving negotiation apparatus 200d may manage the first vehicle state information, the second vehicle state information, and the third vehicle state information because the fourth driving negotiation apparatus 200d receives the third vehicle state information, the second vehicle state information, and the first vehicle state information from the third driving negotiation apparatus 200c.

The fourth driving negotiation apparatus 200d may transmit, to the fifth driving negotiation apparatus 200e, fourth vehicle state information that refer to state information of at least one fourth vehicle within fourth coverage of the fourth driving negotiation apparatus 200d (or a fourth RSU (not illustrated)), the third vehicle state information, the second vehicle state information, and the first vehicle state information. In an embodiment, the fourth driving negotiation apparatus 200d may generate a fourth packet including the fourth vehicle state information, the third vehicle state information, the second vehicle state information, and the first vehicle state information, and may transmit the generated fourth packet to the fifth driving negotiation apparatus 200e.

The fifth driving negotiation apparatus 200e may receive the fourth vehicle state information, the third vehicle state information, the second vehicle state information, and the first vehicle state information from the fourth driving negotiation apparatus 200d. However, the fifth driving negotiation apparatus 200e may manage the fourth vehicle state information, the third vehicle state information, and the second vehicle state information because the management specification has been set to “3”. In this case, the fifth driving negotiation apparatus 200e may manage the remaining fourth vehicle state information, third vehicle state information, and second vehicle state information, except the first vehicle state information of the first driving negotiation apparatus 200a that is farthest from the fifth driving negotiation apparatus 200e, based on driving negotiation apparatus identification information. The fifth driving negotiation apparatus 200e may transmit, to the sixth driving negotiation apparatus 200f, fifth vehicle state information that refer to state information of at least one fifth vehicle within its fifth coverage, the fourth vehicle state information, the third vehicle state information, and the second vehicle state information. In an embodiment, the fifth driving negotiation apparatus 200e may generate a fifth packet including the fifth vehicle state information, the fourth vehicle state information, the third vehicle state information, and the second vehicle state information, and may transmit the generated fifth packet to the sixth driving negotiation apparatus 200f.

The sixth driving negotiation apparatus 200f may receive the fifth vehicle state information, the fourth vehicle state information, the third vehicle state information, and the second vehicle state information from the fifth driving negotiation apparatus 200e. However, the sixth driving negotiation apparatus 200f may manage the fifth vehicle state information, the fourth vehicle state information, and the third vehicle state information because the management specification has been set to “3”.

Accordingly, as illustrated in FIG. 6, the first to sixth driving negotiation apparatuses 200a, 200b, 200c, 200d, 200e, and 200f may manage the state information. In an embodiment, the second driving negotiation apparatus 200b may manage the first vehicle state information. The third driving negotiation apparatus 200c may manage the first vehicle state information and the second vehicle state information. The fourth driving negotiation apparatus 200d may manage the first vehicle state information, the second vehicle state information, and the third vehicle state information. The fifth vehicle negotiation device 200e may manage the second vehicle state information, the third vehicle state information, and the fourth vehicle state information. The sixth vehicle negotiation device 200f may manage the third vehicle state information, the fourth vehicle state information, and the fifth vehicle state information.

If the state information managed by the driving negotiation apparatuses 200a, 200b, 200c, 200d, 200e, and 200f is read in a direction A as illustrated in FIG. 6, the road condition may be parsed from the nearest one.

The management specification (i.e., the management vehicle state information size) that is managed by each of the driving negotiation apparatuses 200a, 200b, 200c, 200d, 200e, and 200f may be adjusted based on road conditions (or a road length) and resources (e.g., a memory capacity and a communication capacity) of the driving negotiation apparatus 200.

For example, assuming that each vehicle has state information of 8 bytes and 100 vehicles are present within coverage of one driving negotiation apparatus 200, the one driving negotiation apparatus 200 may manage state information of 800 bytes. When the management specification (i.e., the management vehicle state information size) is set to “3”, an average of 2.4 kilobit-data may be transmitted between the driving negotiation apparatuses 200.

The driving negotiation apparatus 200 may determine a road state within another piece of coverage based on the vehicle state information that is managed by the driving negotiation apparatus 200.

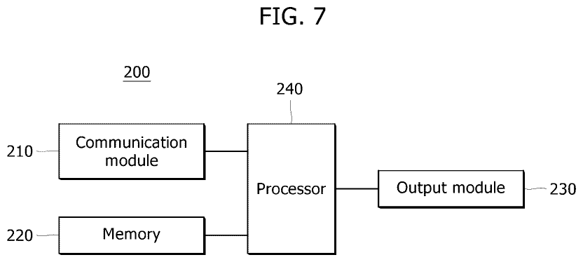

FIG. 7 is a block diagram schematically illustrating a construction of the driving negotiation apparatus according to an embodiment of the present disclosure.

Referring to FIG. 7, the driving negotiation apparatus 200 according to an embodiment of the present disclosure includes a communication module 210, the memory 220, an output module 230, and a processor 240.

The communication module 210 is a component for communication with an adjacent driving negotiation apparatus 200 (or RSU) or a surrounding vehicle over a communication network, and may support vehicle to everything (V2X) communication. The communication module 210 may be implemented in various forms, such as a short-distance communication module, a wireless communication module, a mobile communication module, and a wired communication module.

The memory 220 is a component that stores data related to an operation of the driving negotiation apparatus 200. In particular, the memory 220 may store an application (or a program or an applet) that enables driving negotiation-related operation and state information of at least one vehicle within coverage of the driving negotiation apparatus 200 to be shared with an adjacent driving negotiation apparatus 200. The stored information may be optionally selected by the processor 240, if necessary. The memory 220 may store various types of data that are generated in a process of executing an operating system or an application (or a program or an applet) for driving the driving negotiation apparatus 200. A known storage medium may be used as the memory 220. Any one or more of known storage media, for example, ROM, PROM, EPROM, EEPROM, and/or RAM may be used as the memory 220.

The output module 230 may output information related to driving negotiations and vehicle state information under the control of the processor 240. The output module 230 may include a display module (not illustrated) and an audio module (not illustrated). The display module plays a role to display information related to driving negotiations and vehicle state information under the control of the processor 240. The display module may be implemented with a thin film transistor-liquid crystal display (TFT-LCD) panel, a light emitting diode (LED) panel, an organic LED (OLED) panel, an active matrix OLED (AMOLED) panel, or a flexible panel, for example. The audio module may output information related to driving negotiation and vehicle state information under the control of the processor 240. The audio module may include a speaker, for example.

The processor 240 may be operatively connected to the communication module 210, the memory 220, and the output module 230. The processor 240 may be implemented with at least one of a central processing unit (CPU), an application specific integrated circuit (ASIC), a digital signal processor (DSP), programmable logic devices (PLD), field programmable gate arrays (FPGAs), a micro controller unit (MCU), and/or a system on chip (SoC). The processor 240 may be constructed to control a plurality of hardware or software components connected to the processor 240, by driving an operating system or an application, to perform various types of data processing and operations, to execute at least one instruction stored in the memory 220, and to store the results of the execution and corresponding data in the memory 220.

The processor 240 may perform an operation for driving negotiations.

The processor 240 may generate a packet including state information of a plurality of vehicles within the coverage of the driving negotiation apparatus 200, and may transmit the packet to an adjacent driving negotiation apparatus 200.

Hereinafter, an operation of the processor 240 is described in detail.

An operation of the processor 240 may be different depending on a case in which the driving negotiation apparatus 200 is the first driving negotiation apparatus 200a that performs driving negotiations and a case in which the driving negotiation apparatus 200 is the second driving negotiation apparatus 200b adjacent to the first driving negotiation apparatus 200a that performs driving negotiations.

First, when the driving negotiation apparatus 200 is the first driving negotiation apparatus 200a that performs driving negotiations, an operation of the processor 240 is described.

The processor 240 may perform driving negotiations of a driving negotiation request vehicle.

When completing the driving negotiations, the processor 240 may generate a first packet including state information of a plurality of first vehicles within coverage of the first driving negotiation apparatus 200a, and may transmit the first packet to an adjacent second driving negotiation apparatus 200b.

When performing the driving negotiations of the driving negotiation request vehicle, the processor 240 may receive a cooperation request message from the driving negotiation request vehicle and receive cooperation reply messages from the plurality of first vehicles. The cooperation request message may include vehicle identification information, a time stamp, negotiation request data, and state information. The cooperation reply message may include vehicle identification information, a time stamp, negotiation reply data, state information, and message identification information. The negotiation reply data may include the reply value of the negotiations of the second vehicle itself and information necessary for the negotiations. The reply value of the negotiations may include data elements for agreement or refusal. The state information may include the failure of a vehicle.

The processor 240 may identify state information of the plurality of first vehicles within the first coverage based on the cooperation request message and the cooperation reply message. When the state information of the plurality of first vehicles within the first coverage is identified, the processor 240 may generate a first packet including first vehicle state information indicative of the state information of the plurality of first vehicles. The first packet may include driving negotiation apparatus identification information, coverage flags, a vehicle identifier, and state information (i.e., the failure mode).

Next, when the driving negotiation apparatus 200 is the second driving negotiation apparatus 200b adjacent to the first driving negotiation apparatus 200a that performs the driving negotiation, an operation of the processor 240 is described.

When receiving a first packet from the first driving negotiation apparatus 200a, the processor 240 may determine whether the vehicle in the failure state is present by analyzing the first packet. In an embodiment, the processor 240 may determine whether the vehicle in the failure state is present by identifying the state information (i.e., the failure mode) field of the first packet.

When the vehicle in the failure state is present in the first packet, the processor 240 may broadcast failure vehicle information to at least one second vehicle within the second coverage of the second driving negotiation apparatus 200b. The processor 240 may broadcast the fact that a preceding vehicle on a leading road is in a failure (or abnormal) situation. In response thereto, the at least one second vehicle that has received the failure vehicle information may modify its driving strategy suitably for the failure (or abnormal) vehicle on the leading road. The processor 240 may be aware that there is a problem in the preceding vehicle that drives on the leading road by analyzing the first packet received from the first driving negotiation apparatus 200a, thereby enabling more robust driving negotiation.

The processor 240 may generate a second packet including state information of the at least one second vehicle and state information of the plurality of first vehicles, and may transmit the second packet to an adjacent third driving negotiation apparatus 200c. In an embodiment, the processor 240 may generate the second packet including the state information of the at least one second vehicle within the second coverage and the state information of the plurality of first vehicles, which is received from the first driving negotiation apparatus 200a. Thereafter, the processor 240 may transmit the second packet to an adjacent third driving negotiation apparatus 200c.

The management specification (i.e., the management vehicle state information size) that is managed by the driving negotiation apparatus 200 may be predetermined because resources (e.g., the capacity of the memory 220 and a communication capacity) of the driving negotiation apparatus 200 have been determined. Accordingly, the processor 240 may manage state information, which is received from the driving negotiation apparatus 200 on a leading road, in a size corresponding to the management specification.

Furthermore, the management specification (i.e., the management vehicle state information size) that is managed by the driving negotiation apparatus 200 may be adjusted based on road conditions (e.g., a road length) and resources (e.g., the capacity of the memory 220 and a communication capacity) of the driving negotiation apparatus 200. If a packet including state information is indefinitely transmitted, the internal memory 220 (or buffer) of the driving negotiation apparatus 200 may become insufficient or the transmission speed of data of the driving negotiation apparatus 200 may be limited. Accordingly, the driving negotiation apparatus 200 may set the management specification (i.e., the management vehicle state information size) suitable for a situation, and may overwrite vehicle state information based on the management specification (i.e., the management vehicle state information size) when receiving the state information from an adjacent driving negotiation apparatus 200.

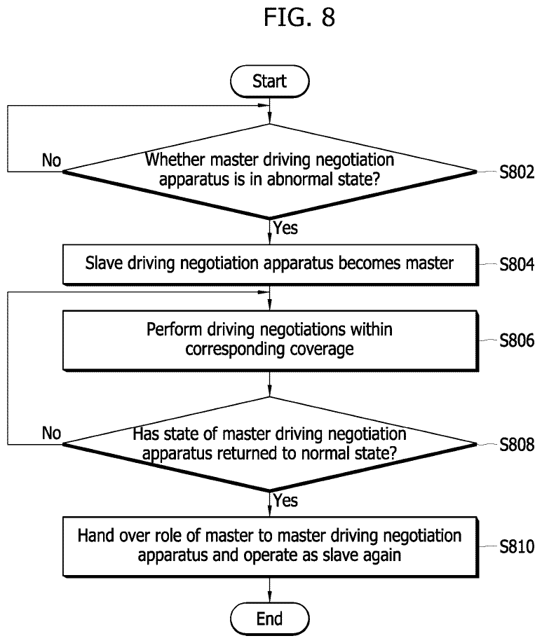

FIG. 8 is a diagram for describing a driving negotiation method of the driving negotiation apparatus that has been dualized according to an embodiment of the present disclosure.

Referring to FIG. 8, in an operation S802, the slave driving negotiation apparatus determines whether the master driving negotiation apparatus is in the abnormal state. In an embodiment, the slave driving negotiation apparatus may transmit a heartbeat packet to the master driving negotiation apparatus at regular intervals in order to identify the state of the master driving negotiation apparatus. The master driving negotiation apparatus in the normal state may transmit a reply packet for the heartbeat packet to the slave driving negotiation apparatus. The master driving negotiation apparatus in the abnormal state is not able to transmit a reply packet for the heartbeat packet to the slave driving negotiation apparatus. Accordingly, if a reply packet for the heartbeat packet is not received from the master driving negotiation apparatus, the slave driving negotiation apparatus may determine the master driving negotiation apparatus to be in the abnormal state.

When the master driving negotiation apparatus is in the abnormal state as the results of the determination in the operation S802, the slave driving negotiation apparatus becomes a master in an operation S804, and performs driving negotiations within coverage of the driving negotiation apparatus in an operation S806. Accordingly, when the master driving negotiation apparatus is in the abnormal state, the slave driving negotiation apparatus may become a master and may perform a role as the master driving negotiation apparatus.

While performing the operation S806, the slave driving negotiation apparatus that has become the master determines whether the state of the master driving negotiation apparatus has returned to the normal state in an operation S808.

While performing the driving negotiations within the coverage, the slave driving negotiation apparatus that has become the master may transmit a heartbeat packet to the master driving negotiation apparatus at regular intervals. When receiving a reply packet for the heartbeat packet from the master driving negotiation apparatus, the slave driving negotiation apparatus that has become the master may determine that the state of the master driving negotiation apparatus has returned to the normal state.

When determining that the state of the master driving negotiation apparatus has returned to the normal state as the results of the determination in the operation S808, the slave driving negotiation apparatus that has become the master hands over the role of the master to the master driving negotiation apparatus and operates as a slave again in an operation S810.

The driving negotiation method and apparatus according to embodiments of the present disclosure may support driving negotiations within a wider range through the exchange of information between the driving negotiation apparatuses installed in different RSUs, by enabling driving negotiations of vehicles within coverage of the RSUs installed in streets.

Furthermore, the driving negotiation method and apparatus according to embodiments of the present disclosure may modify a driving strategy suitably for a failure (or abnormal) vehicle on a leading road and perform even the optimization of the road, by obtaining state information of a vehicle on a leading road that is not included in coverage of a corresponding RSU through the driving negotiation apparatus.

The terms “module,” “unit,” or the like used in this specification may include a unit implemented as hardware, software or firmware, and may be interchangeably used with a term, such as logic, a logical block, a unit, or a circuit. The “module,” “unit,” or the like may be an integrated part, or a minimum unit of the part or a part thereof, which performs one or more functions. For example, according to an embodiment, the “module,” “unit,” or the like may be implemented in the form of an application-specific integrated circuit (ASIC). Furthermore, an implementation described in this specification may be realized as a method or process, an apparatus, a software program, a data stream, or a signal, for example. Although the present disclosure has been discussed only in the context of a single form of an implementation (e.g., discussed as only a method), an implementation of a discussed characteristic may also be realized in another form (e.g., an apparatus or program). The apparatus may be implemented as proper hardware, software, or firmware. The method may be implemented in an apparatus, such as a processor commonly referring to a processing device, including a computer, a microprocessor, an integrated circuit, or a programmable logic device, for example. The processor includes a communication device, such as a computer, a cell phone, a mobile phone/personal digital assistant (“PDA”), and another device which facilitate the communication of information between end users.

The present disclosure has been described above with reference to the embodiments illustrated in the accompanying drawings, but the embodiments are merely illustrative. A person having ordinary skill in the art to which the present disclosure pertains should understand that various modifications and other equivalent embodiments are possible from the embodiments. Accordingly, the technical range of protection of the present disclosure should be determined by the appended claims.

What is claimed is:

1. A driving negotiation method comprising:
transmitting, by a first processor of a first driving negotiation apparatus of a first roadside unit (RSU), a first packet including state information of a plurality of first vehicles within first coverage of the first RSU to a second driving negotiation apparatus of an adjacent second RSU, when completing driving negotiations;
broadcasting, by a second processor of the second driving negotiation apparatus, failure vehicle information to at least one second vehicle within second coverage of the second RSU when a vehicle in a failure state is present in the first packet; and
transmitting, by the second processor, a second packet including state information of the at least one second vehicle and the state information of the plurality of first vehicles to a third driving negotiation apparatus of an adjacent third RSU.

2. The driving negotiation method of claim 1, wherein one or both of the first packet or the second packet includes at least one of driving negotiation apparatus identification information, coverage flags, a vehicle identifier, or a failure mode.

3. The driving negotiation method of claim 2, wherein:
the coverage flags include inner coverage and outer coverage, and
the failure mode indicates whether a corresponding vehicle fails.

4. The driving negotiation method of claim 1, wherein a vehicle state information size that is managed by each of the first driving negotiation apparatus, the second driving negotiation apparatus, and the third driving negotiation apparatus is adjusted depending on resources of each of the first driving negotiation apparatus, the second driving negotiation apparatus, and the third driving negotiation apparatus.

5. The driving negotiation method of claim 1, further comprising:
after transmitting the second packet to the third driving negotiation apparatus,
broadcasting, by a third processor of the third driving negotiation apparatus, the failure vehicle information to at least one third vehicle within third coverage of the third RSU when the vehicle in the failure state is present in the second packet, and
transmitting, by the third processor, a third packet including state information of the at least one third vehicle, the state information of the at least one second vehicle, and the state information of the plurality of first vehicles to a fourth driving negotiation apparatus of an adjacent fourth RSU.

6. The driving negotiation method of claim 5, wherein the first driving negotiation apparatus, the second driving negotiation apparatus, and the third driving negotiation apparatus are sequentially installed in a driving direction of a vehicle.

7. A driving negotiation apparatus comprising:
a communication module configured to support vehicle to everything (V2X) communication; and
a processor connected to the communication module,
wherein the processor is configured to transmit, to an adjacent driving negotiation apparatus, a first packet including state information of a plurality of first vehicles within coverage of the driving negotiation apparatus when completing driving negotiations of a driving negotiation request vehicle.

8. The driving negotiation apparatus of claim 7, wherein the processor is configured to:
when receiving a cooperation request message from the driving negotiation request vehicle, complete the driving negotiations of the driving negotiation request vehicle by:
generating a cooperation relay message that comprises a type code of additional information necessary for negotiations in the cooperation request message,
broadcasting the cooperation relay message to the plurality of first vehicles, receiving cooperation reply messages corresponding to the cooperation relay message from the plurality of first vehicles, and
transmitting a message for negotiability or non-negotiability to the driving negotiation request vehicle based on the cooperation reply message.

9. The driving negotiation apparatus of claim 7, wherein the first packet includes at least one of driving negotiation apparatus identification information, coverage flags, a vehicle identifier, or a failure mode.

10. The driving negotiation apparatus of claim 9, wherein:
the coverage flags include inner coverage and outer coverage, and
the state information indicates whether a corresponding vehicle fails.

11. The driving negotiation apparatus of claim 7, wherein the adjacent driving negotiation apparatus is installed on a following road of the driving negotiation apparatus in a driving direction of the driving negotiation request vehicle.

12. The driving negotiation apparatus of claim 7, wherein the processor is configured to, when receiving a packet from the adjacent driving negotiation apparatus, analyze the received packet and broadcasts failure vehicle information to at least one vehicle within coverage of the driving negotiation apparatus when a vehicle in a failure state is present in the received packet.

13. The driving negotiation apparatus of claim 12, wherein the adjacent driving negotiation apparatus is installed on a leading road of the driving negotiation apparatus in a driving direction of the driving negotiation request vehicle.

14. The driving negotiation apparatus of claim 12, wherein the processor is configured to transmit, to an adjacent driving negotiation apparatus, a packet comprising state information of the at least one vehicle included in the received packet and the state information of the plurality of first vehicles.

15. The driving negotiation apparatus of claim 7, wherein a vehicle state information size that is managed by the driving negotiation apparatus is adjusted depending on resources of the driving negotiation apparatus.
